(19) United States
(12) Patent Application Publication
(10) Pub. No.: US 2025/0093847 A1
(43) Pub. Date: Mar. 20, 2025

(54) COMPUTATIONALLY GENERATED GRIPPERS

(71) Applicant: University of Washington, Seattle, WA (US)

(72) Inventors: Jeffrey Lipton, Sharon, MA (US); Ian Good, Seattle, WA (US); Milin Kodnongbua, Seattle, WA (US); Yu Lou, Seattle, WA (US); Adrianna Schulz, Seattle, WA (US)

(21) Appl. No.: 18/728,378

(22) PCT Filed: Jan. 10, 2023
(86) PCT No.: PCT/US2023/060390

§ 371 Date: Jul. 11, 2024

Related U.S. Application Data
(60) Provisional application No. 63/339,284, filed on May 6, 2022.
(60) Provisional application No. 63/298,752, filed on Jan. 12, 2022.

(51) Int. Cl. G05B 19/4099; B29C 64/386; B33Y 10/00; B33Y 30/00; B33Y 50/00

(52) U.S. Cl. CPC G05B 19/4099; B29C 64/386; B33Y 10/00; B33Y 30/00; B33Y 50/00; G05B 2219/49008

(57) ABSTRACT

Passive grippers can be computationally generated for grasping objects. For example, a method described herein for producing a passive gripper for the object can include identifying a set of grasp configurations for the object. The method can also include selecting, from the set, a particular grasp configuration configured for performing passive engagement and disengagement with the object. Additionally, the method can include generating a template for the passive gripper based on the particular grasp configuration. The method can include fabricating the passive gripper based on the template.

### CROSS-REFERENCES TO RELATED APPLICATIONS

This application claims the benefit of U.S. Provisional Application No. 63/298,752 filed Jan. 12, 2022, and U.S. Provisional Application No. 63/339,284 filed May 6, 2022, the entire contents of each are hereby incorporated for all purposes in their entirety.

### STATEMENT AS TO RIGHTS TO INVENTIONS MADE UNDER FEDERALLY SPONSORED RESEARCH AND DEVELOPMENT

This invention was made with government support under Grant No. 2035717, awarded by the National Science Foundation (NSF). The government has certain rights in the invention.

### BACKGROUND OF THE INVENTION

Passive grippers can be end-effectors with no actuation. Passive grippers can leverage existing degrees of freedom in a robotic arm to perform grasping tasks. Grasping techniques associated with passive grippers can provide advantages. These advantages can include reducing the manufacturing and deployment cost when compared to techniques associated with active grippers. The advantages can also include lower energy consumption since passive grippers do not require continuous power. Additionally, passive grippers can enable easier human-robot-interaction as anything passively grasped can be removed by a human without changing a robot state. A fundamental limitation to the widespread use of passive grippers, however, is that passive grippers can be significantly restricted in the types of shapes that can be grasped.

### BRIEF SUMMARY OF THE INVENTION

A custom gripper and an accompanying grasp insert trajectory can be automatically generated for stable pickup of an input shape. For example, a method of producing a passive gripper for an object described herein can include identifying a set of grasp configurations for the object. The method can also include selecting, from the set, a particular grasp configuration configured for performing passive engagement and disengagement with the object. Additionally, the method can include generating a template for the passive gripper based on the particular grasp configuration. The method can include fabricating the passive gripper based on the template.

In another example, a system described herein can include a robotic arm configured to move relative to an object. The system can also include a processor and a memory. The memory can include instructions executable by the processor for causing the processor to perform operations. The operations can include identifying a set of grasp configurations for the object. The operations can also include selecting, from the set, a particular grasp configuration configured for performing passive engagement and disengagement with the object. Additionally, the operations can include generating a template of a passive gripper configured to contact the object at the particular grasp configuration. The system can also include a manufacturing device configured to fabricate the passive gripper based on the template and such that the passive gripper is attachable to the robotic arm to be configured to contact the object at the particular grasp configuration.

In another example, a method for producing a gripper for two or more objects described herein can include identifying two or more sets of grasps configurations, each set of grasp configurations associated with one of the two or more objects. The method can also include selecting, from the two or more sets of grasps configurations, a combination of particular grasp configurations, the combination configured to grasp at least one object of the two or more objects. Additionally, the method can include generating a template for the gripper, the gripper configured to contact the at least one object using the combination of the particular grasp configurations. The method can include fabricating the gripper based on the template.

### BRIEF DESCRIPTION OF THE DRAWINGS

FIG. 1 is a schematic of a manufacturing environment for generating a passive gripper to grasp an object according to one example of the present disclosure.

FIG. 2 is a block diagram of a computing device for generating a passive gripper for grasping an object according to one example of the present disclosure.

FIG. 3 is a schematic of several examples of grasp configuration (GC) candidates for an object to be grasped by a generated passive gripper according to one example of the present disclosure.

FIG. 4 is a schematic of an example of a skeleton used to optimize a gripper shape and an insert trajectory for grasping an object according to one example of the present disclosure.

FIG. 5 is a schematic of an example of a passive gripper for grasping an object according to one example of the present disclosure.

FIG. 6 is a flow chart of a process for fabricating a passive gripper for grasping an object according to one example of the present disclosure.

FIG. 7A is a schematic of an example of an unreachable GC associated with a circle according to one example of the present disclosure.

FIG. 7B is a schematic of an example of a reachable GC associated with a circle according to one example of the present disclosure.

FIG. 7C is a schematic of a second example of a reachable GC associated with a 2D object according to one example of the present disclosure.

FIG. 8A is a schematic that illustrates a concept of gripper collision energy according to one example of the present disclosure.

FIG. 8B is a schematic that illustrates a concept of trajectory collision energy according to one example of the present disclosure.

FIG. 9A is a schematic that illustrates inside distance and wrap-around distance for a rectangular shape according to one example of the present disclosure.

FIG. 9B is a schematic that illustrates a different inside distance and a different wrap-around distance for a rectangular shape according to one example of the present disclosure.

FIG. 9C is a schematic that illustrates inside distance and wrap-around distance for an irregular shape according to one example of the present disclosure.

FIG. TOA is a schematic that illustrates inside distance and wrap-around distance for a path that includes a single pair of entering and exiting intersections through a shape according to one example of the present disclosure.

FIG. 10B is a schematic that illustrates inside distance and wrap-around distance for a path that includes two pairs of entering and exiting intersections through a shape according to one example of the present disclosure.

FIG. 10C is a schematic that illustrates inside distance and wrap-around distance for a path that includes a single pair of entering and exiting intersections through multiple shapes according to one example of the present disclosure.

FIG. 11 is a schematic depicting a computation of a collision-free volume as a complementary space of swept volume of an object moving away from a gripper according to one example of the present disclosure.

FIG. 12 is a schematic of an evaluation set of 22 objects according to one example of the present disclosure.

FIG. 13A is a schematic that illustrates a measurement of a post-grasp maximum roll angle for a passive gripper according to one example of the present disclosure.

FIG. 13B is a schematic that illustrates a measurement of a post-grasp maximum forward tilt angle for a passive gripper according to one example of the present disclosure.

### DETAILED DESCRIPTION OF THE INVENTION

Rapid-manufacturing and design optimization can be used to expand the space of shapes that can be passively grasped. Certain aspects and examples of the present disclosure relate to systems and methods that, given an input shape, can automatically generate a 3D printable custom gripper and an accompanying grasp insertion trajectory for stable pickup. The systems and methods can be directly applicable to a plethora of robotics applications that target repetitive tasks. For example, the systems and methods can be used for task-specific tooling of robotic work cells in assembly lines, which may allow assembly lines instrumented with simple robotic systems (i.e., systems that lack dexterity) to be easily updated to respond to changes in a product. New passive grippers can simply be optimized and printed in a short timeframe (e.g., overnight) and can re-purpose existing hardware.

Challenges associated with optimizing a passive gripper for the given input shape can include: (1) verifying that a valid insert trajectory exists for contacting an object and (2) once contact is made, stably lifting the object. A large-scale search for the custom gripper and the accompanying grasp insertion trajectory can occur, nominally at the resolution of a 3D printer. Performance evaluation can be expensive to compute since the performance evaluation can involve physical evaluation and a nested optimization.

The challenges can be addressed with two fundamental insights that allow complexity of the large-scale search to be reduced. The first fundamental insight is a recognition that stability can be a function of contact points between the passive gripper and the object. The contact points can be referred to as a grasp configuration (GC), The GC can be exposed as a design variable that should be optimized. Given the GC, the insert trajectory can include a criterion that a gripper exists whose final insert configuration touches the GC and can be inserted without colliding with a rest of a shape of the object. The second insight is that the insert trajectory can be found by creating a generalization of a gripper geometry or a skeleton that reflects minimal requirements and by then running a co-optimization over a space of trajectories and abstracted gripper shapes. The generalization can be a parametric skeleton of infinitesimal thickness that connects points of the GC to a flange frame's origin (FFO) of a robot. The passive gripper can be mounted at a center of the FFO. The parametric skeleton can reflect a criterion that a rigid gripper be attached to the FFO and contacts the points of the GC.

Based on the two insights, a two-step approach can optimize the GC for stability and then, co-optimize the insert trajectory and the generalization given the GC. But a chance of successfully finding a feasible insertion trajectory may depend on a choice of the GC. Therefore, a strategy can include computing a ranked list of stable GC candidates that are likely to enable a collision-free insert trajectory. The ranked list of stable GC candidates can be used to co-optimize the trajectory and gripper generalization. Once the insert trajectory and the GC are found, a straightforward modification of classic topology optimization algorithms can be used for computing gripper geometry.

Robot design can involve specifying both geometries and actuation sequences. Traditional methods can start with a general-purpose geometry and then customize an actuation. The traditional methods can be useful given a cost of manufacturing and a relative ease of re-programming. However, a revolution in digital fabrication and a resulting ease of customization can open a new era of task-specific robot design. A body of recent work can support advantages of jointly optimizing a robot's shape and actuation for a variety of tasks such as ground locomotion, flying, swimming, and grasping. The present application builds on a new trend, but instead of customizing a whole robot, the systems and methods described herein can enhance a general-purpose robot with customized end-effectors that can be rapidly fabricated, lowering the cost of customization.

Past work on generative gripper design has focused on active grippers. Antipodal grasping was an early target for computational design efforts, with researchers developing shaped fingertips for antipodal grasping using direct formulaic approaches and neural network techniques. Vacuum-based gripper design can be another direction of focus. A user can specify target locations, and then a 3D printable manifold and superstructure can be generated for a specific object. The present application expands on these ideas to passive grippers.

Many grippers have been classified as passive only because they passively conform to an object (as in the case of compliant and soft robotics). Some so-called passive grippers can rely on actuators to release a grasp. Truly passive grippers can have zero degrees of freedom and can have no reliance on actuators. The most widely deployed passive grippers in industry can include forklifts, but forklifts can only be used on objects specifically designed for forklifts, e.g., pallets, shipping containers, and flexible intermediate bulk container (FIBC) bags. Previously proposed passive grippers can use a rotational motion to engage an antipodal grasp, but the previously proposed passive grippers can only pick up extruded cross sections (e.g., a cylinder). Other work has focused on passive deformations around objects to apply antipodal forces.

Table 1 summarizes object shape restrictions posed by different types of grippers. The forklifts can pick up objects around center of masses (CoM) and through internal pickup (e.g., holes and handles). Active parallel jaw grippers or other passive grippers that generate antipodal grasps can work well on a variety of objects because they can create opposing forces anywhere on the objects and do not rely on gravity at the CoM for the opposing force. However, active parallel jaw grippers can suffer from picking up objects via internal structures and objects that are antipodal resistant. Parallel jaw grippers with custom fingertips may be able to pick up an antipodal resistant part due to a large conformable gripping area of the parallel jaw grippers. Vacuum-based grippers can pick up a wide variety of objects with large enough flat surfaces. Table 1 highlights characteristics of objects and is not a strict classification. By covering a larger number of characteristics, the present application can significantly expand the space of objects that can be passively grasped.

TABLE 1
Comparison of different grippers based on characteristics
of objects the different grippers can lift.

| | | | Grips | Extruded |
|---|---|---|---|---|
| | Internal | Antipodal | outside | Cross |
| Gripper | Pickup | Resistant | CoM | Section |
| Described in Present | ✓ | ✓ | ✓ | |
| Application | | | | |
| Non-Actuated Forklift | ✓ | | | |
| Described in Mucchiani et al. | | | ✓ | ✓ |
| 2018/2021 | | | | |
| Antipodal (active or passive) | | | ✓ | ✓ |
| Antipodal (active) and | | ✓ | ✓ | ✓ |
| Custom Fingertips | | | | |
| Vacuum-based (active) | | ✓ | ✓ | ✓ |

All grippers can include a criterion for a grasp planning step and numerous methods have been applied for simplifying the grasp planning step. Force closure can be a fundamental metric for evaluating a grasp. The grasp can be force closed if the grasp resists any arbitrary set of forces and torques. The grasp can be partially force closed if the grasp resists all but a subset of forces and torques. Alternatively, the caging of an object can be evaluated kinematically. A kinematic evaluation can include an array of obstacles placed around the object to limit the range of motion of the object. A downside of the kinematic evaluation is that locating the object relative to the robot when grasped can be difficult. Thus, force closed grasps are focused on in the present application.

A challenge with physics-based methods for grasp point selection can include modeling noise. Deep learning techniques can generate robust grasp poses both in a constrained 2.5D bin picking setting and even a full cluttered 6D grasp pose setting. Alternatively, visuomotor policies can be learned directly from raw visual data. While learning methods successfully generate grasp candidates, the learning methods can be trained primarily for antipodal and vacuum grippers and may be not directly applied to passive grippers.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

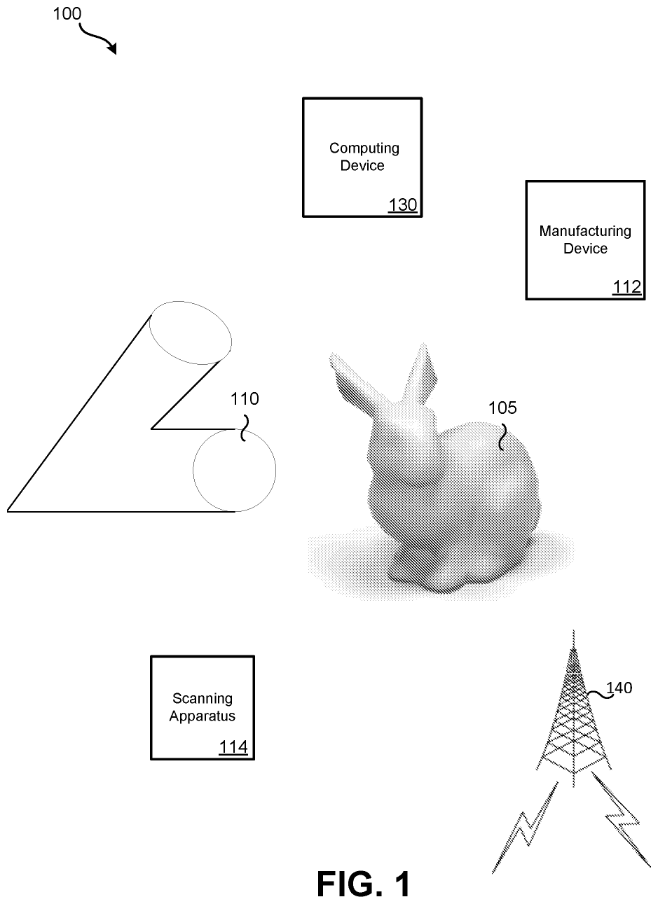

FIG. 1 is a schematic of a manufacturing environment 100 for generating a passive gripper to grasp an object 105 according to one example of the present disclosure. The manufacturing environment 100 can include the object 105, a computing device 130, one or more communication networks 140, a grasping base 110, a manufacturing device 112, and a scanning apparatus 114, or any combination with one or more of these or other elements. The grasping base 110, the manufacturing device 112, and the scanning apparatus 114 may send or receive information from the computing device 130 over the one or more communication networks 140. The one or more communication networks 140 may correspond to one or more Wide Area Networks (“WANs”), such as the Internet, through which the grasping base 110, the manufacturing device 112, the scanning apparatus 114, and the computing device 130 may communicate with servers via web browsers or user-side applications, to establish communication sessions, request and receive web-based resources, and access other features of applications or services. The computing device 130, the manufacturing device 112, the scanning apparatus 114, and the grasping base 110 can be in electrical communication with each other. Although illustrated in the manufacturing environment 100 in FIG. 1, the computing device 130 can be situated in a remote location away from the manufacturing environment 100.

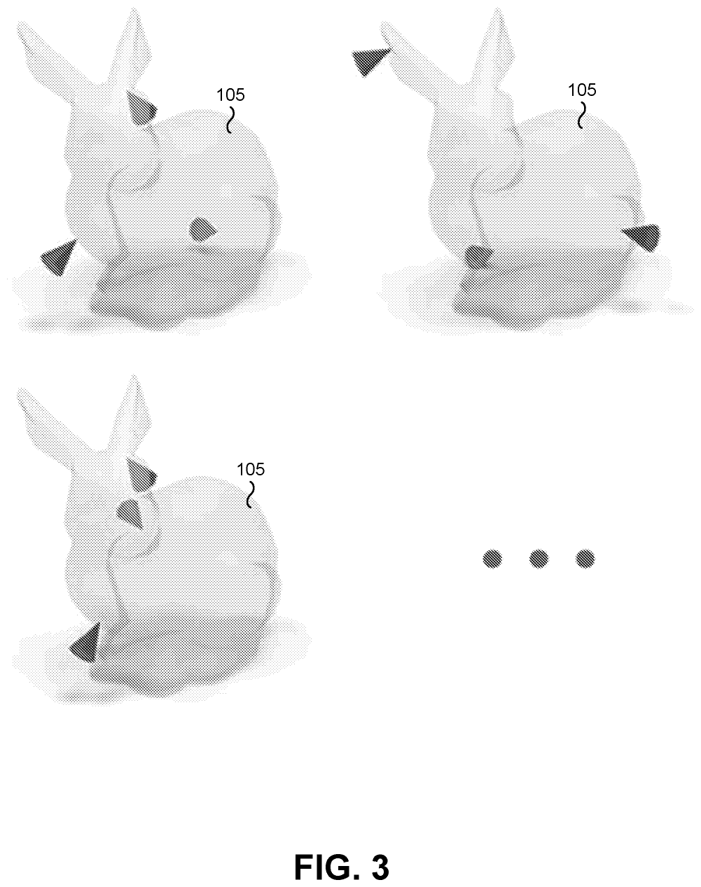

The grasping base 110 can be a robotic structure or the robotic structure can include the grasping base 110. In some examples, the grasping base 110 is not associated with a robotic structure. For instance, the grasping base 110 can be a handle or tool suitable for use by a human user. Examples of the grasping base 110 can include jigs or fixtures. The grasping base 110 can be mountable to a fixed surface such as a table to hold the object 105 in place. In some examples, a shape of the object 105 can be imported from a user provided file. Alternatively (or additionally), the scanning apparatus 114 can scan the object 105, determine the shape of the object 105 and/or a position of the object 105, and send the shape and/or position information to the computing device 130. The computing device 130 can receive shape and/or positioning information of the object 105 as well as a kinematic structure of the robot structure as inputs and generate (1) a passive gripper template (or model) and (2) a collision-free insert trajectory for creating a stable grasp of the object 105. In some examples, the passive gripper template can be shared with the manufacturing device 112 and a passive gripper can be fabricated based on the passive gripper template. In some examples, the manufacturing device 112 is a 3D printer and the passive gripper can be 3D printed based on the passive gripper template. Other examples of the manufacturing device can include a computer numerical control (CNC) machine, a laser direct metal laser melting additive machine, or another additive or subtractive manufacturing machine. The passive gripper can be an end effector of a tool or handle suitable for use by a human in some examples. The computing device 130 can implement an algorithm that can involve three steps as illustrated in FIGS. 3-5.

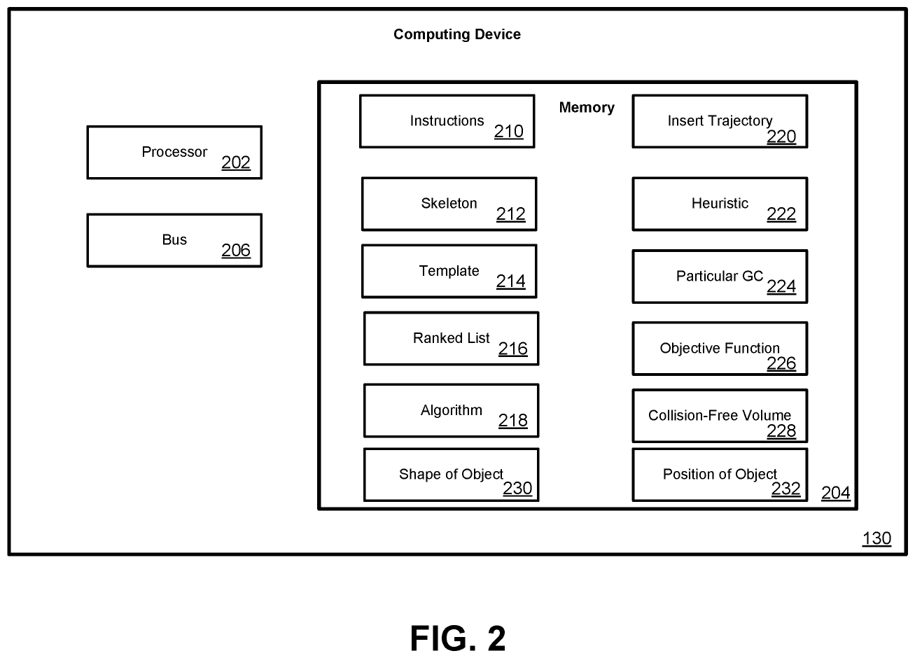

FIG. 2 is a block diagram of a computing device 130 for generating a passive gripper for grasping an object 105 according to one example of the present application. The components shown in FIG. 2, such as a processor 202, a memory 204, a bus 206, and the like, may be integrated into a single structure such as within a single housing of the computing device 130. Alternatively, the components shown in FIG. 2 can be distributed from one another and in electrical communication with each other.

As shown, the computing device 130 includes the processor 202 communicatively coupled to the memory 204 by the bus 206. The processor 202 can include one processor or multiple processors. Non-limiting examples of the processor 202 include a Field-Programmable Gate Array (FPGA), an application specific integrated circuit (ASIC), a microprocessor, or any combination of these. The processor 202 can execute instructions 210 stored in the memory 204 to perform operations. In some examples, the instructions 210 can include processor-specific instructions generated by a compiler or an interpreter from code written in any suitable computer-programming language, such as C, C++, C#, or Java.

The memory 204 can include one memory device or multiple memory devices. The memory 204 can be non-volatile and may include any type of memory device that retains stored information when powered off. Non-limiting examples of the memory 204 include electrically erasable and programmable read-only memory (EEPROM), flash memory, or any other type of non-volatile memory. At least some of the memory 204 can include a non-transitory computer-readable medium from which the processor 202 can read instructions 210. The non-transitory computer-readable medium can include electronic, optical, magnetic, or other storage devices capable of providing the processor 202 with the instructions 210 or other program code. Non-limiting examples of the non-transitory computer-readable medium include magnetic disk(s), memory chip(s), RAM, an ASIC, or any other medium from which a computer processor can read instructions 210.

Additionally, the memory 204 can include a skeleton 212, a template 214 for a gripper, a ranked list 216 of GC candidates, an algorithm 218, an insert trajectory 220, a heuristic 222, a particular GC 224, an objective function 226, a shape 230 of an object 105, a position 232 of the object 105, and a collision-free volume 228. The processor 202 can use the heuristic 222 to help establish the ranked list 216 of GC candidates. The particular GC 224 can be selected from the ranked list 216. The processor 202 can determine a skeleton 212 and the insert trajectory 220 based on the shape 230 and position 232 of the object 105. The processor 202 can use the algorithm 218 to co-optimize the skeleton 212 and the insert trajectory 220. The co-optimization can be based on a minimization of the objective function 226. Once the skeleton 212 is optimized, the processor 202 can generate a template 214 for the gripper by performing discrete topology optimization over the collision-free volume 228.

FIG. 3 is a schematic of several examples of grasp configuration (GC) candidates for an object 105 to be grasped by a generated passive gripper according to one example of the present disclosure. The arrows in FIG. 3 indicate locations of contact points on the object 105. The contact points can be referred to as the GC. As illustrated in FIG. 3, each GC candidate can include three different contact points. An algorithm 218 described herein can involve generating a ranked list of the GC candidates.

GC selection can be uniquely responsible for final stability. But GC selection can also impact the likelihood for finding a valid insert trajectory and possible trade-offs between compliance and weight in another step of the algorithm 218. At least four metrics can be considered in ranking GC candidates: (1) a binary metric that validates static stability under gravity; (2) a measurement of robustness-a minimum disturbance force and torque that can make an object unstable; (3) a heuristic to identify GCs that are unlikely to have a valid insert trajectory; and/or (4) an estimate of final gripper weight. Metrics (1) and (3) can be used to prune randomly sampled GCs, and metrics (2) and (4) can be used to rank the remaining GCs.

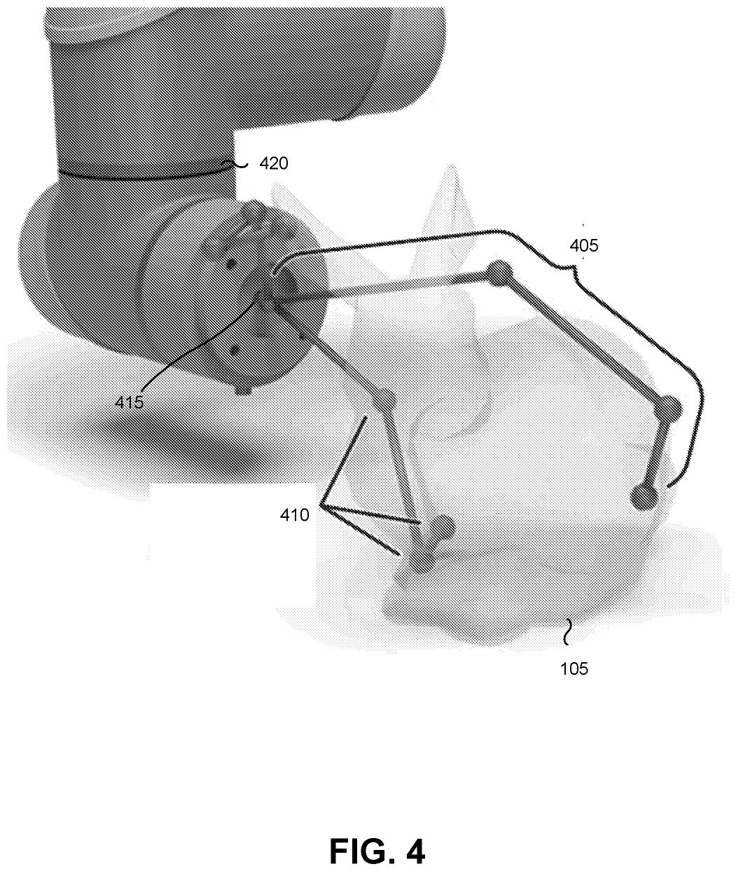

The algorithm 218 can involve searching for a collision-free insert trajectory 220 for a given GC. The trajectory search can be completed by jointly optimizing the insert trajectory 220 and a gripper generalization. The gripper generalization can be referred to as a skeleton 212. FIG. 4 is a schematic of an example of the skeleton 212 used to optimize a gripper shape and the insert trajectory 220 for grasping an object 105 according to one example of the present disclosure. The skeleton 212 can include several fingers 405 and each finger can include several joints 410. For instance, the skeleton 212 can include three fingers 405 and each finger can include three joints 410 (as illustrated in FIG. 4). The skeleton 212 can be used to link contact points for the given GC to a robotic arm 420.

To optimize the collision-free insert trajectory 220, one GC from the ranked list 216 can be considered at a time. An algorithm 218 can involve searching for a collision-free insert trajectory 220 for a given GC. If a best GC fails to find a collision-free insert trajectory 220, the algorithm can proceed to the next best GC in a ranked list of GC candidates. Collision avoidance can be a challenging objective since collision avoidance can depend on both the insert trajectory 220 and an overall shape of a gripper. The challenge can be simplified by ignoring structural cost for the gripper. A geometric aspect that affects collision can involve how contact points of the GC are connected to an FFO 415 and how a connecting structure moves through time.

Gripper geometry can be represented by the gripper generalization (the skeleton 212), which can include parametrized curves that connect the FFO 315 to each contact point of the GC. The algorithm 218 can jointly optimize over a space of skeletons and insert trajectories by minimizing a cost function associated with collision. A trajectory complex regularization term can be added to the cost function. The trajectory complex regularization term can reward a simpler insert trajectory which reduces a chance of collision, leave more collision-free space to optimize a gripper shape, and/or lower energy consumption of a robot.

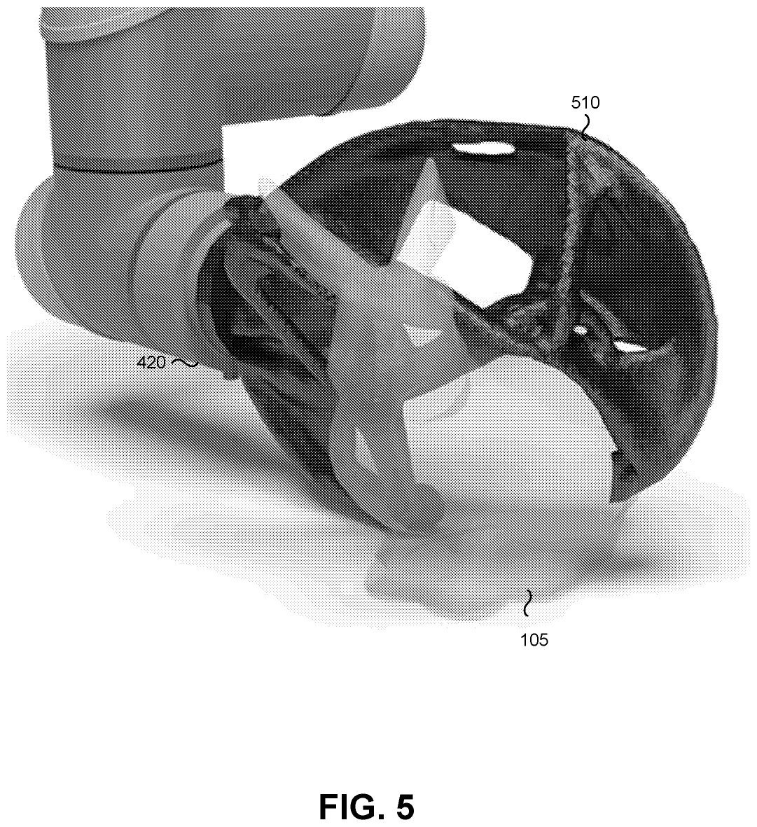

FIG. 5 is a schematic of an example of a passive gripper 510 for grasping an object 105 according to one example of the present disclosure. An algorithm 218 can involve computing a passive gripper template 214. While the skeleton 212 could serve as a workable gripper, the skeleton 212 can be too fragile. An alternative can be found by computing a volumetric region that does not intersect with the object 105 during insert motion. The collision-free volumetric region can be used as a gripper template 214. But a gripper that uses the full collision-free volumetric region can be too heavy. Therefore, topology optimization can be used to generate the final passive gripper template 214, e.g., simultaneously minimizing compliance and weight, while constraining the generated passive gripper template 214 to lie within the collision-free volumetric region. A passive gripper 510 can be fabricated by a manufacturing device 112 based on the passive gripper template 214 and attached to a robotic arm 420.

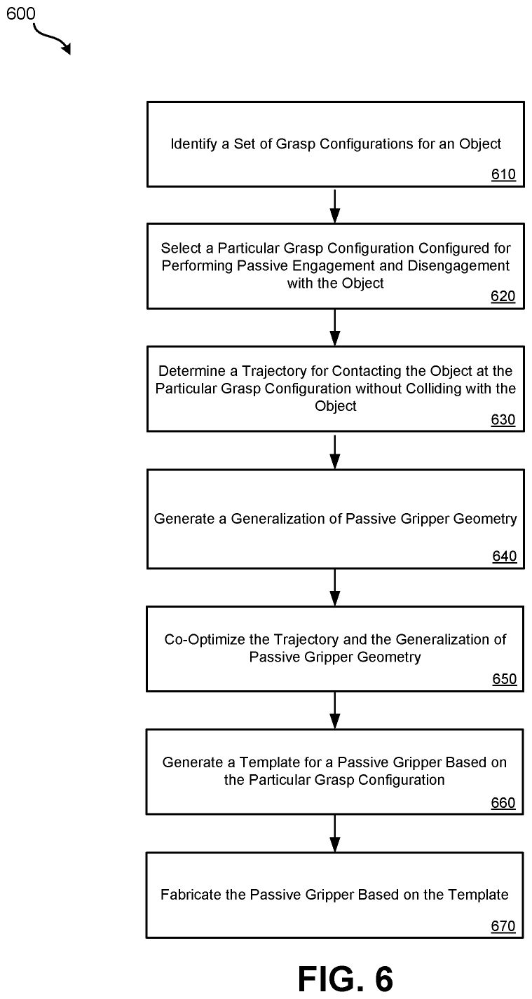

FIG. 6 is a flow chart of a process 600 for fabricating a gripper for grasping an object 105 according to one example of the present disclosure. In some examples, the gripper is a passive gripper 510. Operations of processes may be performed by software, firmware, hardware, or a combination thereof. The operations of the process 600 can start at block 610.

At block 610, the process 600 involves identifying a set of GCs for the object 105. A GC can be a set of three contact points on a target object 105. Three contact points are chosen because three can be the minimum number of points necessary to constrain a rigid body like the object 105. More contact points can kinematically over-constrain a solution, make finding a collision-free trajectory a tougher challenge, and/or make a gripper more sensitive to an approach direction. Identifying a set of GCs can include generating a ranked list 216 of GC candidates. Generating the ranked list 216 of GC candidates can involve multiple steps.

One of the steps can involve a method for sampling GCs. A sampling scheme can identify points on a surface of the object 105 that do not contact a floor and that can be directly connected to an FFO 415 without colliding with the object 105. GCs (e.g., sets of three of the identified points) can be selected uniformly at random from among the identified points. GCs that are not statically stable under gravity and GCs that are identified as unreachable (i.e., candidates that are unlikely to have a collision-free gripper shape and grasp insert trajectory 220) can be disqualified. The remaining GCs can be ranked to maximize a robustness to external disturbances once the object 105 is grasped, while trading-off compliance and weight of a gripper shape by using another heuristic metric.

Each contact point can make a contribution to stability of the object 105 by exerting forces onto the object 105 at different angles and location. Coulomb's model of friction can be assumed to be valid. The Coulomb's model of friction can limit an angle with respect to a surface at which the forces can be exerted. For contact point i, a constraint exists: |fᵢ^{T}|≤μᵢ|fᵢ^{N}| where fᵢ^{T} and fᵢ^{N} are tangential and normal forces exerted, respectively; and μᵢ is a coefficient of friction at the contact point i. The constraint can be represented by a cone and can be approximated using a polyhedral cone with q sides, where an allowed force can be a non-negative linear combination of edges of the polyhedral cone, called a basis. A wrench (force and torque) generated by j-th basis of the polyhedral cone at point i can be denoted by wᵢⱼ. A contribution from an i-th contact point can be written as Σⱼ₌₁^{q}kᵢⱼwᵢⱼ, where kᵢⱼ≥0.

Stability for a GC can be determined using a partial force closure, which can specify whether a grasp can withstand a particular external disturbance (i.e., a force of gravity). Formally, a partial force closure condition can be met if there exists a kᵢⱼ≥0 such that Σⱼ₌₁³Σⱼ₌₁^{q}kᵢⱼwᵢⱼ=[g 0]^{T}, where g is a unit vector of gravity. The GC can be considered stable if the GC meets the partial force closure condition.

A slight problem can arise when using partial force closure as a formulation of force contribution for passive grasping because the force of gravity does not directly cause top-facing contact points to generate forces. Instead, the gripper only generates a contact force if a non-zero torque around a CoM exists. To account for this, a frictional force generated by the top-facing contact points can be set to zero and frictional forces generated by the bottom-facing points can be set depending on the angle with respect to the ground. Formally, a coefficient of friction at point i can be set to μᵢ=max (0, nᵢ·g)μ where μ is a base coefficient of friction.

A stronger grasp condition called force closure exists which can specify whether a grasp can withstand any external forces and torques. However, this stronger grasp condition which typically involves contact points on different sides of the object can make breaking contact more difficult. By utilizing gravity, the object 105 can still be held stable without a force closure grasp. Hence, the partial force closure condition can be sufficient.

For a given GC, determining if a collision-free trajectory exists can be expensive since the determination involves solving a co-optimization problem. A heuristic 222 that can quickly identify unreachable GCs can be helpful. The heuristic 222 can search for existence of an instantaneous motion where all contact points of the GC simultaneously break contact with the object 105. If the existence of the instantaneous motion cannot be confirmed by the heuristic 222, the GC can be dropped as an unreachable GC.

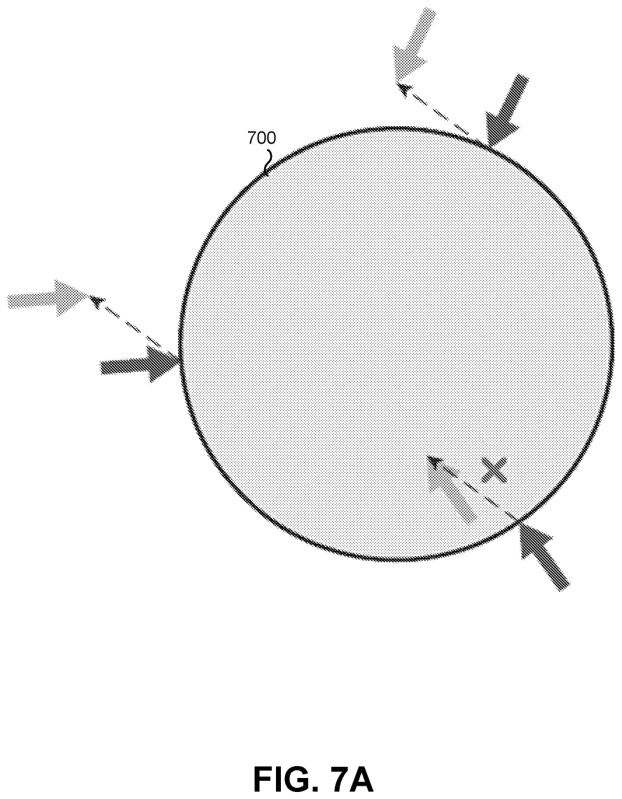

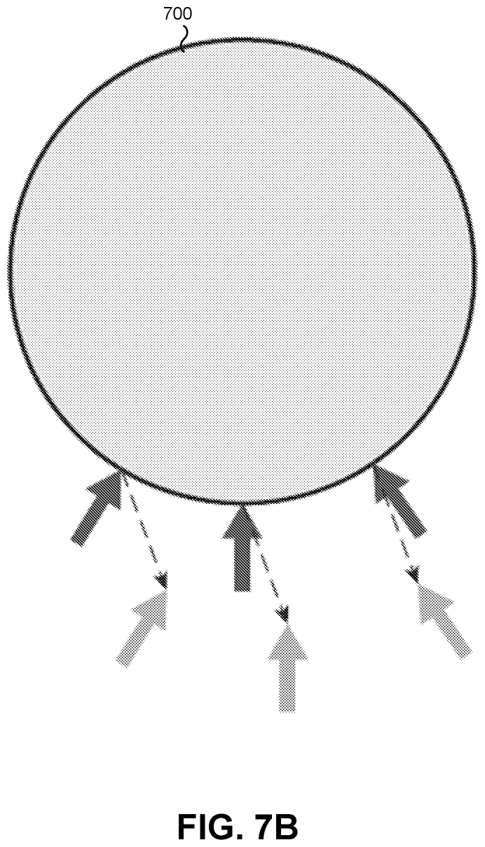

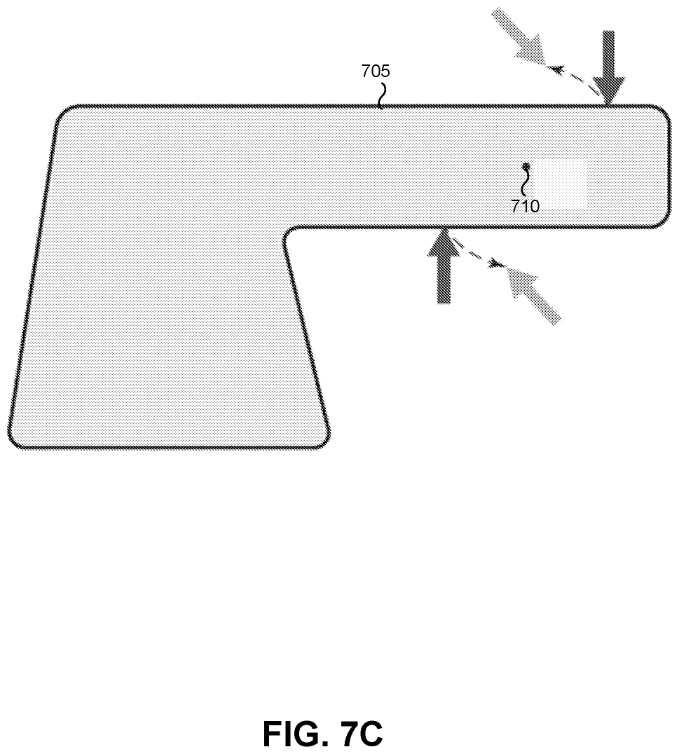

Aspects of a 2D version of the heuristic 222 are illustrated in FIGS. 7A-C. The aspects can extend naturally to a 3D version. FIG. 7A is a schematic of an example of an unreachable GC associated with a circle 700 according to one example of the present disclosure. FIG. 7A depicts contact points of the GC at three equally spaced locations (denoted by bold arrows) along a circumference of the circle 700 in a 2D space. No rigid motion can be found that would break all three contact points simultaneously without colliding with the circle 700. Thus, the GC shown in FIG. 7A can be identified as an unreachable GC and the GC of FIG. 7A can be dropped without running an expensive optimization.

FIG. 7B is a schematic of an example of a reachable GC associated with the circle 700 according to one example of the present disclosure. FIG. 7B depicts points of the GC at three locations roughly on a single semicircle of the circle 700. All three of the contact points can simultaneously break contact with the circle 700 by moving the contact points away along normals to the circle. Thus, the GC depicted in FIG. 7B can be identified by a heuristic 222 as a reachable GC. An analysis of the GC depicted in FIG. 7B can suggest that a particular GC can be tested for reachability by checking to see if normals for all contact points are pointing in the same semicircle. But this reachability test could be too strict as illustrated by FIG. 7C.

FIG. 7C is a schematic of a second example of a reachable GC associated with a 2D object 705 according to one example of the present disclosure. The GC in FIG. 7C has two contact points. The normals associated with the two points of contact are pointing in opposite directions. The “same semicircle” reachability test introduced in the description of FIG. 7B would suggest that the GC in FIG. 7C is an unreachable GC. But the GC depicted in FIG. 7C can be identified as a reachable GC. Both contact points can simultaneously break contact with the 2D object 705 by rotating both contact points counterclockwise around a midpoint 710 between the two contact points.

A 2D or 3D heuristic 222 can search for an instantaneous rigid motion (translation and rotation) so that all contact points simultaneously sufficiently break contact with the object 105. The instantaneous motion of the gripper can be described by (v, ω, c), where v is an instantaneous translational velocity and ω is an instantaneous angular velocity around a rotation center c. The instantaneous velocity associated with a single contact point, i, can be denoted as vᵢ=v+ω×(cᵢ−c) where cᵢ is a position for the single contact point. The single contact point can break contact if vᵢ·nᵢ≥0 where nᵢ is a normal direction at the single contact point. An angle between vᵢ and nᵢ can be limited to a maximum value θₘₐₓ to avoid nearly parallel motion to a surface of the object 105. Formally, if there does not exist a motion (v, ω, c) such that vᵢ·nᵢ∥vᵢ∥cos(θₘₐₓ) for all i, then the GC can be identified as unreachable.

A loss function, inspired by a barrier method, can be constructed to penalize motions that violate the constraints. A minimization problem can be solved using a standard gradient-based optimization to find a valid motion:

$${min}_{( v , ω , c )} {\sum }_{i} [ {[ cos ( {θ}_{max} ) - {v}_{i} \cdot {n}_{i} ]}_{+} + {[ ‖ {v}_{i} ‖ - 1 ]}_{+} ]$$

where [⋅]₊ denotes max (0,⋅).

Note, vᵢ is not normalized in order to avoid numerical instability when the magnitude of vᵢ approaches zero. The angle between vᵢ and nᵢ can be maintained below θₘₐₓ by ensuring ∥vᵢ∥≤1. A GC can be identified as unreachable if the loss function does not converge to zero.

The ranked list 216 of candidate GCs can be produced by considering two metrics. A first metric can evaluate a minimum disturbance force that causes the object 105 to become unstable. The first metric measures a stability of a grasp after the object 105 is picked up and experiences a transfer motion. A metric called a partial minimum wrench can be introduced to measure a minimum additional external wrench that would violate the partial force condition. Intuitively, the partial minimum wrench metric can correspond to a maximum tilt angle and/or a maximum acceleration that an object held by a specified GC can experience before falling off. A higher value for the partial minimum wrench can be preferable to a lower value.

A second metric can include an estimated finger length. If contact points of the specified GC are far from an FFO 415, a corresponding gripper can be cumbersome and a path to reach the FFO 415 can be long. Therefore, the estimated finger length can be determined by finding the shortest non-colliding path from the FFO 415 to each contact point and taking the maximum path length from those outcomes. A shorter value for the estimated path length can be preferable to a longer value.

Since the first metric can conflict with the second metric, a ranking scheme can follow a non-dominated sorting criteria in multi-objective optimization. Candidates can be segmented into multiple Pareto frontiers and candidates within each frontier can be sorted based on the estimated finger length.

Returning to FIG. 6, at block 620, the process 600 involves selecting, from the set of GCs, a particular GC 224 configured for performing passive engagement and disengagement with the object 105. The particular GC 224 can be selected from the ranked list 216 of candidate GCs. The particular GC 224 can be the first GC in the ranked list 216. In some examples, if an insert trajectory 220 or a skeleton 212 cannot be optimized for the particular GC 224, a second particular GC can be selected from the ranked list 216. In some examples, the particular GC 224 can be manually specified or user specified.

At block 630, the process 600 involves determining an insert trajectory 220 for contacting the object 105 at the particular GC 224 without colliding with the object 105. The collision-free insert trajectory 220 can be sought for each particular GC 224 selected. Since collisions can depend on a shape of a gripper as well as the insert trajectory 220, the shape and the insert trajectory 220 can be designed together. A fundamental challenge associated with the co-design of the gripper and the insert trajectory 220 can include a complexity of a combined search space. A nominal search space of gripper geometry can correspond to a resolution of a voxel grid that a 3D printer can afford. A search space of the insert trajectory 220 can be described by degrees of freedom of a robotic arm over time. A combined search for an optimal insert trajectory 220 and gripper geometry can be made tractable with a reduced representation of the combined search space.

At block 640, the process 600 involves generating a generalization of passive gripper geometry, the generalization connecting the particular GC to a point on a grasping base 110. The generalization of the passive gripper geometry can be represented by a skeleton 212. For example, the skeleton 212 can include three fingers 405 and multiple joints 410 connecting the FFO 415 to the contact points of the particular GC 224. The representation of the skeleton 212 can stem from a criterion that grasping points be connected to the FFO 415. The skeleton 212 can include infinitesimal thickness and can be used to evaluate collisions over 2D curves as opposed to volumes. Manufacturability can be accounted for by expanding a mesh by an offset that corresponds to half a value for resolution for the 3D printer.

The insert trajectory 220 can be represented as a linear interpolation between a list of robot states in a joint space. The list of robot states can be referred to as keyframes for the insert trajectory 220. A first keyframe can define a robot state when the gripper is outside a proximity of the object 105. A last keyframe can define a robot state when the gripper makes contact with the object 105.

The skeleton 212 can be defined as [symbol] ∈ [symbol] ^{3×m×3} is the number of joints 410 in each finger 405. The insert trajectory can be defined by [symbol] ∈ [symbol] ^{n×d} where n is the number of keyframes and d is a number of degrees of freedom for a robot. A tuple, ( [symbol] (x), [symbol] (x)), can be optimized using x∈ [symbol] ^{N} as adjustable parameters. Specifically, the adjustable parameters can include intermediate joint positions for every finger, and intermediate insert trajectory keyframes, for a total of N:=3·(m−2)·3+d·(n−2) parameters. According to some examples of the present disclosure, m=4, n=4, and d=6, resulting in 30 degrees of freedom total. An initial guess based on an initialization method described below can be denoted ( [symbol] (0), [symbol] (0)). Appropriate ranges (σ∈ [symbol] ^{N}) can be specified for each of the adjustable parameters (i.e., −σᵢ≤xᵢ≤σᵢ) to ensure that the combined search space is connected and that a solution remains valid (e.g., the robot does not self-intersect and the skeleton 212 maintains an overall shape). For simplicity, in the following description, x is omitted and [symbol] and [symbol] are meant to imply [symbol] (x) and [symbol] (x).

At block 650, the process 600 involves co-optimizing the insert trajectory 220 and the generalization of passive gripper geometry. To co-optimize the insert trajectory 220 and the skeleton 212, an objective function 226 can be established that includes four energy terms: a gripper collision energy E_{g}, a trajectory collision energy Eₜ, a robot collision energy Eᵣ, and a trajectory regularizer L. The first three terms focus on collision, while the regularizer penalizes complex trajectories.

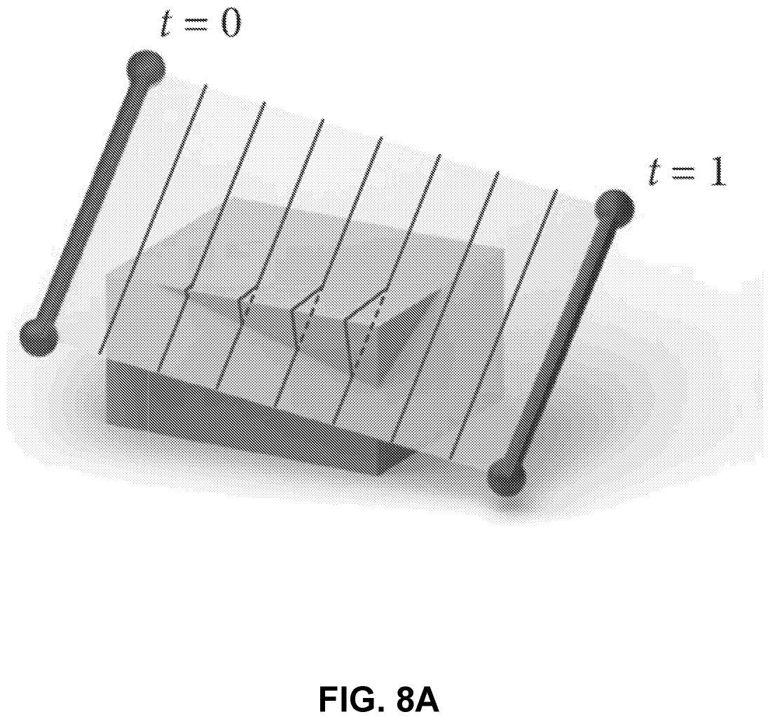

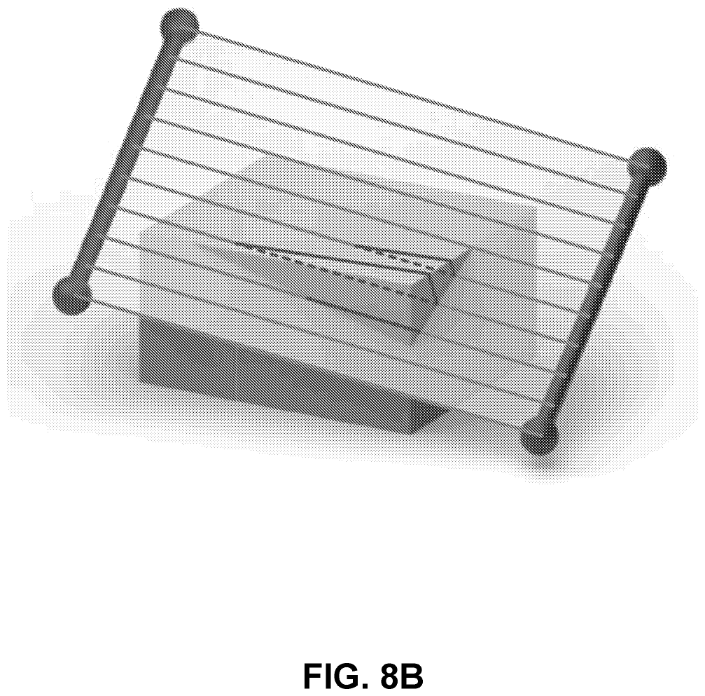

The gripper collision energy can be defined as a maximum collision at any point of the insert trajectory 220 measured over the whole skeleton 212. Similarly, the trajectory collision energy can be defined as a maximum collision of a single point in the skeleton 212 measured over the whole insert trajectory 220. FIG. 8A is a schematic that illustrates a concept of gripper collision energy according to one example of the present disclosure. In terms of gripper collision energy, collision can be computed along a path along the skeleton 212 tested at different time steps (shown with vertical lines) in the insert trajectory 220. Collisions by the path are shown as dashed lines in FIG. 8A.

FIG. 8B is a schematic that illustrates a concept of trajectory collision energy according to one example of the present disclosure. In terms of trajectory collision energy, collision can be computed along a path along the insert trajectory 220 tested at different points (shown with horizontal lines) on the skeleton 212. Collisions by the path are shown as dashed lines in FIG. 8B. In theory, either one of these two collision energies can individually represent a collision error. In practice, however, the two collision energies are not conducive to be directly computed. Instead, the two collision energies can be evaluated over a discretization of the insert trajectory 220 and the skeleton 212. A motivation for combining these two collision energy metrics is that the two collision energies describe two basis directions for a surface, which can make an evaluation over a discretization robust to small features.

Both the gripper collision energy and the trajectory collision energy can depend on a measurement of collision over a path. The collision of the skeleton 212 at any point can be expressed as the sum of a collision of the fingers 405 (piece-wise linear paths). The collision of a point throughout the whole insert trajectory 220 can be measured from a path traced by the point.

Since a robot end-effector cannot go lower than a certain clearance height h, the robot collision energy term, Eᵣ, can be introduced as a maximum penetration into ground by a position of an FFO 415. A complexity of the insert trajectory 220 can be penalized using an L2 norm of trajectory variations (i.e., trajectory components in x) from an initial guess.

An optimizer minimizes the following energy sum:

$${min}_{x} {E}_{g} ( 𝒢 , ) + {E}_{t} ( 𝒢 , ) + {λ}_{1} {E}_{r} ( ) + {λ}_{2} L ( )$$

where λ₁ and λ₂ define a significance for the robot collision energy and a significance for the trajectory regularizer, respectively. The energy sum can be the objective function 226. Since the energy sum is non-differentiable, a controlled random search (CRS) with local mutation can be used to minimize the energy sum.

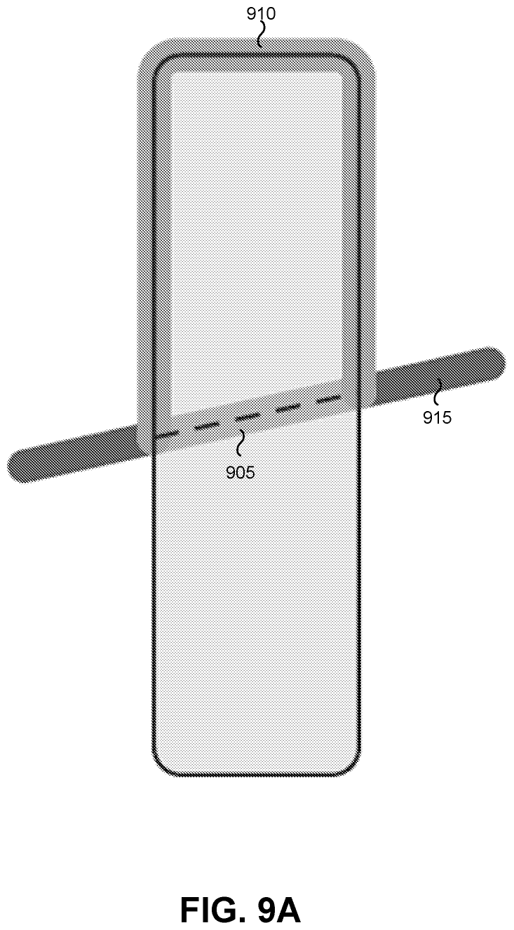

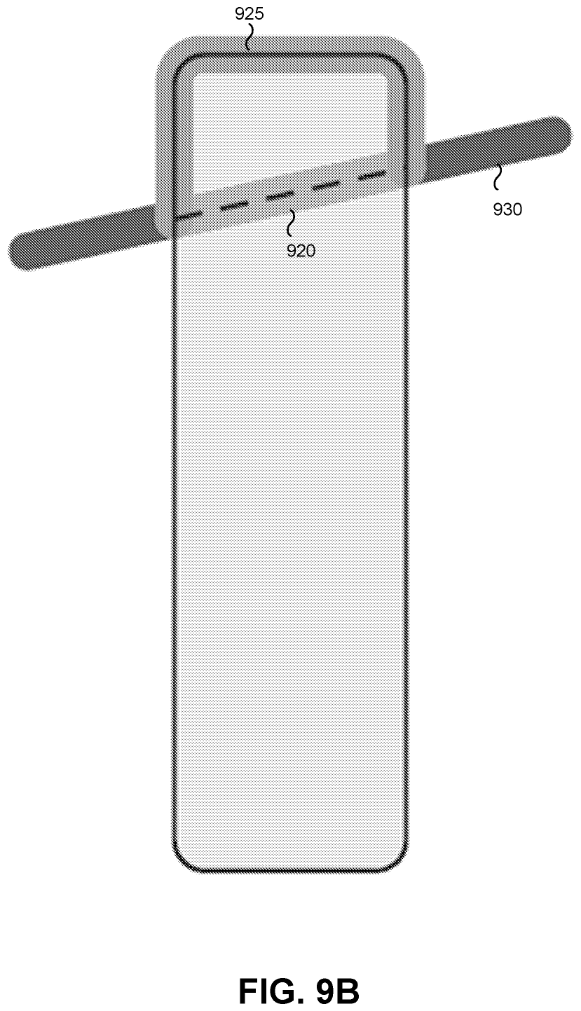

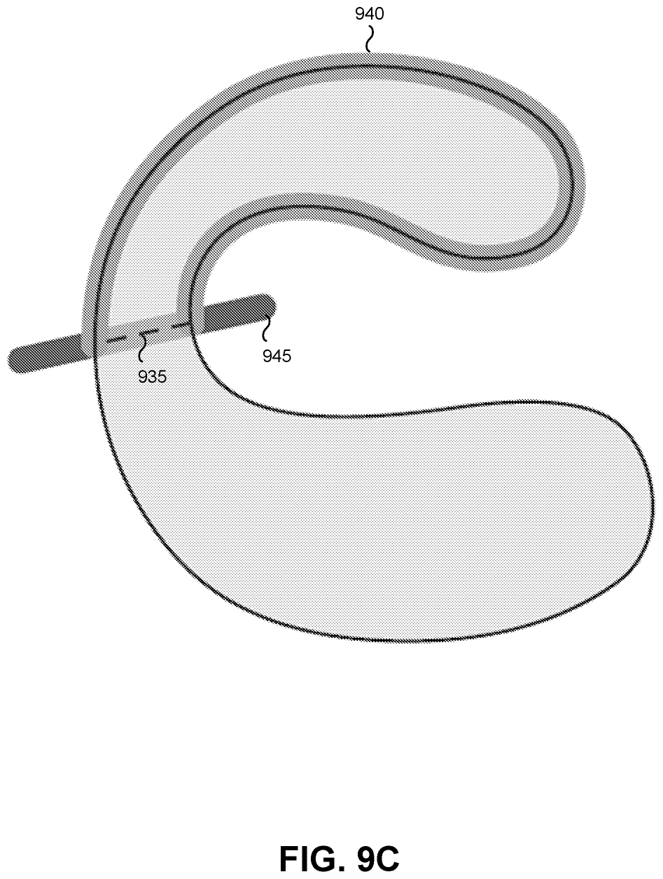

Several approaches can be taken to compute a collision for a given path. One trivial approach can include using a length of path that lies inside the object 105. The length can be called the inside distance. However, this trivial approach does not capture a degree of the collision, as illustrated in FIGS. 9A-C. A measurement of a shortest additional distance to make the path collision-free can be included. The shortest additional distance can be called wrap-around distance. To measure the wrap-around distance, a geodesic distance between a pair of points when the path enters and exits the object 105 can be computed. A sum of geodesics can be found if the path enters and exits the object 105 multiple times. The geodesic computation may be not needed if one or both endpoints of the path are in the object. The collision of the path can be defined as the sum of the inside distance and the wrap-around distance.

FIG. 9A is a schematic that illustrates inside distance 905 and wrap-around distance 910 for a path 915 through a rectangular shape according to one example of the present disclosure. FIG. 9B is a schematic that illustrates inside distance 920 and different wrap-around distance 925 for a different path 930 through a rectangular shape according to one example of the present disclosure. FIG. 9C is a schematic that illustrates inside distance 935 and wrap-around distance 940 for a path 945 through an irregular shape according to one example of the present disclosure. The inside distances of paths in FIGS. 9A and 9B are equivalent but the path 945 in FIG. 9B is closer to a collision-free state than the path 915 shown in FIG. 9A. The path 945 in FIG. 9C has a shorter inside distance 935 than the paths in FIG. 9A and FIG. 9B, but the path 945 in FIG. 9C is quite far from a collision-free state.

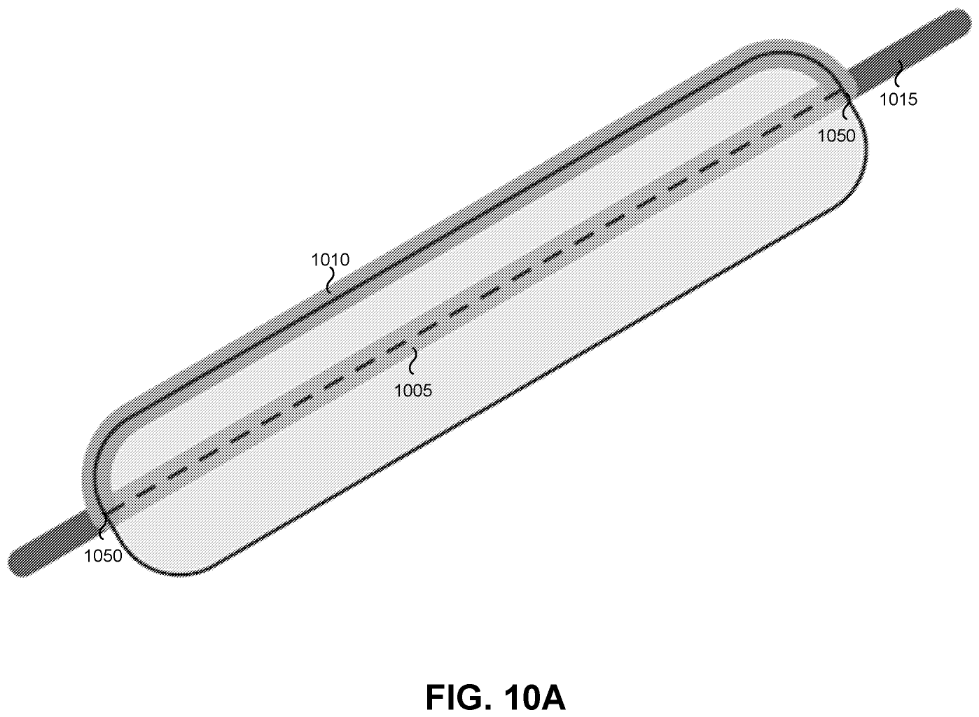

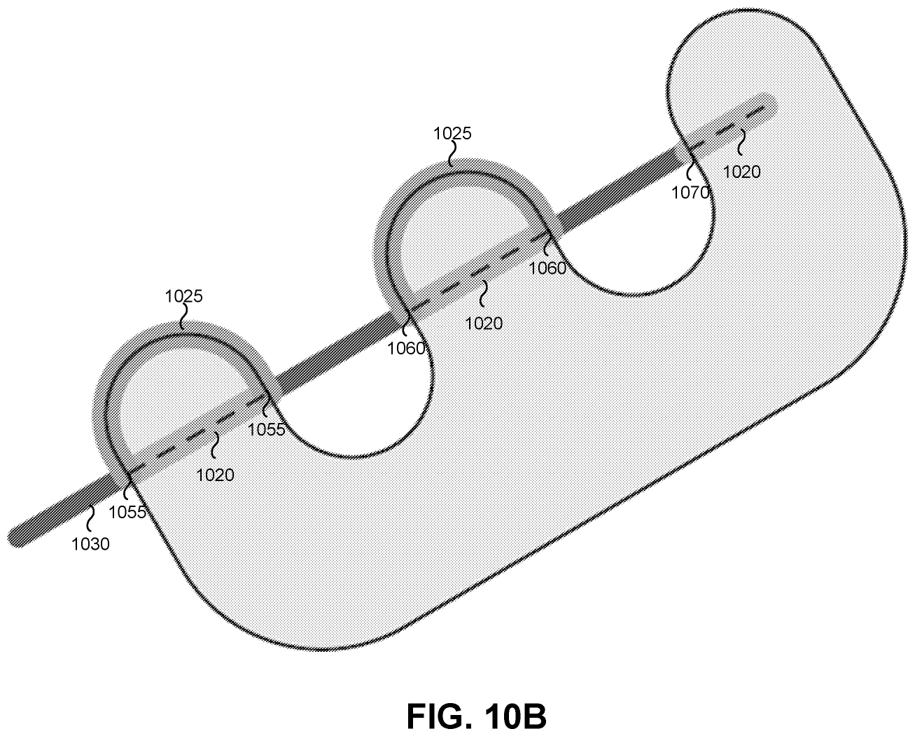

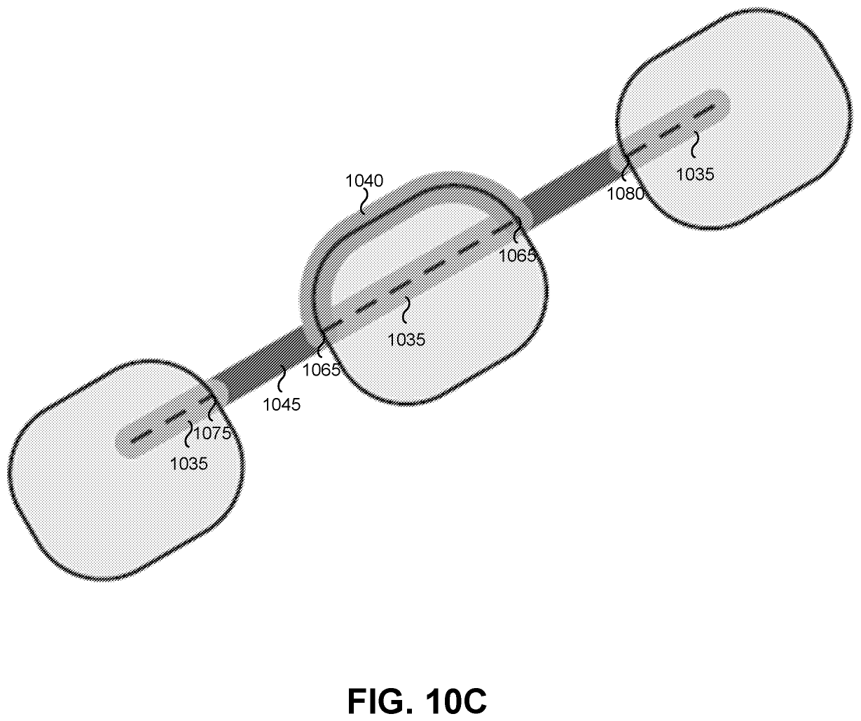

FIG. 10A is a schematic that illustrates inside distance 1005 and wrap-around distance 1010 for a path 1015 that includes a single pair 1050 of entering and exiting intersections through a shape according to one example of the present disclosure. FIG. 10B is a schematic that illustrates inside distance 1020 and wrap-around distance 1025 for a path 1030 that includes two pairs (1055 and 1060) of entering and exiting intersections through a shape according to one example of the present disclosure. FIG. 10C is a schematic that illustrates inside distance 1035 and wrap-around distance 1040 for a path 1045 that includes a single pair 1065 of entering and exiting intersections through multiple shapes according to one example of the present disclosure. The wrap-around distance can be a sum of the geodesics between every pair of entering and exiting intersections. Some endpoints, such as 1070 in FIG. 10B and 1075 and 1080 in FIG. 10C, do not have a pair and therefore geodesics may be not defined.

E_{g} and Eₜ can be computed by sampling the insert trajectory 220 and the skeleton 212, respectively. The insert trajectory 220 can be adaptively subdivided so that the skeleton 212 moves by at most some distance d_{sub} and the fingers 405 can be adaptively subdivided by a same distance. The sampling can be repeated for every iteration as lengths of individual segments can significantly change when adjustable parameters change.

To find where the path enters and exits the object 105, ray-tracing algorithms can be used to find intersections. Since the path for the insert trajectory 220 is not linear, the path can be adaptively subdivided with some linearity intolerance dₗᵢₙ into connected line segments.

To efficiently compute the geodesic distance between any given two points, some accuracy trade-offs may be needed. The geodesic distance can be approximated by running a standard shortest path algorithm on vertices and edges of a triangle mesh. An isotropic remeshing algorithm can be used to generate a new mesh whose edge lengths are as close to one another as possible. Generating the new mesh can make the approximation more accurate. The shortest distance can be precomputed between every pair of vertices. The approximate geodesic distance for any given two points on the surface can be computed as the distance of those two points to the closest associated vertices plus the precomputed geodesics between the two vertices.

The skeleton 212 can be initialized by computing shortest, non-colliding curves that connect from the FFO 415 to each contact point and then simplifying the curves to a correct number of joints by discretizing the curves, expanding the curves by a surface normal, and removing vertices that do not contribute to collision avoidance. The insert trajectory 220 can be initialized to be a straight line towards the object 105.

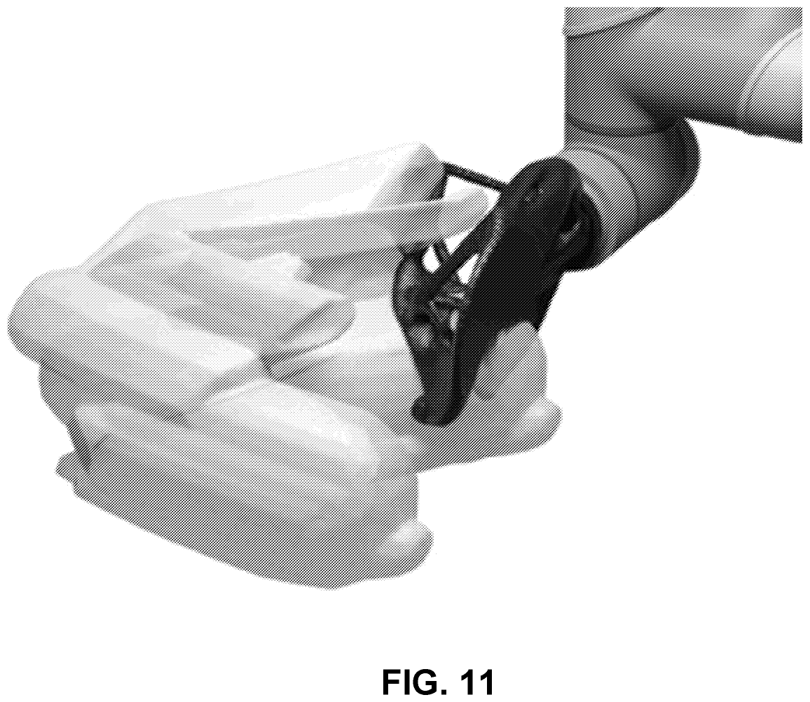

Returning to FIG. 6, at block 660, the process 600 involves generating a template 214 for a passive gripper 510 based on the particular GC 224. The template 214 for the passive gripper 510 can be generated by performing discrete topology optimization over a collision-free volume 228. Since the insert trajectory 220 is known, the collision-free volume 228 can be computed as a complementary space of swept volume of the object 105 moving away from the gripper 510 (see FIG. 11). For boundary conditions, external forces can be set to be forces exerted by the contact points of the particular GC 224 along normal directions and that fix parts of the gripper 510 around the FFO 415. In post-processing, a smoothing kernel can be applied and marching cubes can be ran to retrieve a smooth mesh. Gripper geometry of the template 214 can be further refined by adding a small sphere at each contact point of the particular GC 224 and subtracting the swept volume to ensure an accurate geometry around the contact points. Further refining the gripper geometry of the template 214 can increase area of contact and improve a robustness of grasp. Robot-specific mounting structures such as holes and a mounting plate can be added for fast installation. The template 214 for the passive gripper 510 can be based on the optimized skeleton 212 and insert trajectory 220. In some examples, instead of generating the template 214, a preformed articulated gripper capable of changing shape can be modified to form a shape of the optimized skeleton 212 and attach to the object 105 via the optimized insert trajectory 220.

At block 670, the process 600 involves fabricating the passive gripper 510 based on the template 214. The passive gripper 510 can be fabricated using a manufacturing device. Examples of the manufacturing device can include a 3D printer, a computer numerical control (CNC) machine, a laser direct metal laser melting additive machine, or other additive or subtractive manufacturing machine. A single manufacturing device can be used to fabricate the entire passive gripper 510. In some examples, one manufacturing device can be used to fabricate a portion of the passive gripper 510 and another manufacturing device can be used to fabricate the rest of the passive gripper 510. Materials for the passive gripper 510 can include TangoBlackPlus, Acrylonitrile butadiene styrene (ABS), plastics, powders, metals, carbon fibers, graphite, graphene, nitinol, paper, etc.

In some examples, a gripper can be configured to grasp at least one of two or more objects. In these examples, two or more sets of GCs can be identified, each set of GCs can be associated with one of the two or more objects. A final gripper can be a result of a combination of GCs. One particular GC can be active at a time to grab one object of the two or more objects using robot motion associated with the one object. Other GC's in the combination may be inactive while the particular GC is active. Different objects may utilize different robot motion to engage an appropriate GC. For each particular active GC, an algorithm may optimize a skeleton and insert trajectory for the active GC, e.g., taking into account the other inactive GCs that could lead to subsequent insert trajectories that may collide with the object. If two GCs (each with three contact points) have at least two contact points similarly spaced, the two GCs may share two contact points to reduce overall complexity. For example, if two contact points in a first GC are 5 cm apart and two contact points in a second GC are also 5 cm apart, the GCs can be repositioned so that two contact points overlap, e.g., reducing the total contact points to four instead of six. In some examples, selecting a particular GC can involve selecting, from the two or more sets of grasp configurations, a combination of particular grasp configurations. The combination of particular grasp configurations can be configured to grasp at least one object of the two or more objects. Each of the particular grasp configurations in the combination of the particular grasp configurations can be connected to the other particular grasp configurations in the combination by a series of paths.

The gripper configured to grasp at least one of two or more objects can be active or passive. The gripper can include suction cups or other forms of contact pads. One or more of the contact pads can move along the series of paths to grasp at least one object of the two or more objects.

### EXAMPLES

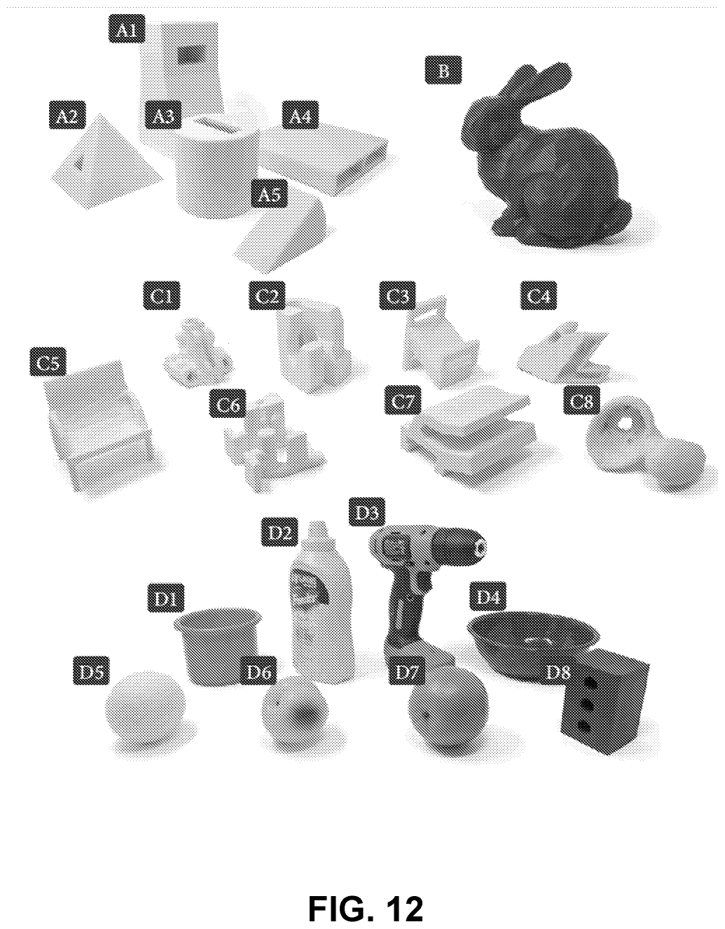

An evaluation set of 22 objects was created (See FIG. 12). Five models were engineered to demonstrate capabilities of generated templates 214 and fabricated passive grippers. Objects A1-A3 were designed to represent internal structures. A1 contained an L-shaped hole in front. Several approaches can be taken to compute a collision for a given path. A pyramid (A2) contained a curved hole that required a twist motion for insert. A “Top Key” (A3) contained a rectangular slot on top and required a quarter turn to insert. A pallet (A4) was designed to test of an algorithm could generate a fork-lift passive gripper template. A wedge (A5) was engineered to resist an antipodal grasp because of a tapered shape of the wedge (A5) for all orientations. Objects (A2) and (A5) may have been not successfully passively lifted prior to implementing techniques from the present application.

In addition, a representative set of objects from a prior work was included. To uphold a Special Interest Group on Computer Graphics and Interactive Techniques (SIGGRAPH) tradition, a Stanford bunny (B) was added to the evaluation set. Some challenging objects (C1-C8) were chosen from a Fit2Form dataset representing adversarial objects from Dex-Net 2.0 and objects from ShapeNet. A subset (D1-D8) of feature-rich YCB objects containing no moving parts were also included in the evaluation set.

Inputs for algorithm 218 included shape and positioning of an object 105. Two experiments were run for object A1 using orthogonal positions: insertion from a front and from a side. The two experiments were referred to as front key (A1-f) and side key (A1-s). In total, 23 experiments were performed (2 experiments for A1 and 1 experiment for each of the other 21 objects).

The algorithm 218 was implemented in C++, using libigl and CGAL for most mesh processing tasks. UR5 was used as a robot with six degrees of freedom. A code was used to calculate swept volume and ToPy was used to run topology optimization with a voxel size of 2 millimeters. The algorithm 218 was run on a cluster with 40 cores for all 23 experiments.

In a GC generation stage, 1,000 points were randomly sampled, and 3,000 GCs were generated. The base coefficient of friction p was assumed to be 0.5 in modeling contacts. For a reachability heuristic 222, θₘₐₓ was set to 80°. In computing collision of a path, a subdivision distant threshold (d_{sub}) and a linearity threshold of the trajectory (dₗᵢₙ) were both set to 1 millimeter. In computing a total objective function, a robot floor clearance (h), robot energy significance (λ₁), and a regularizer significance (λ₂) were set to 0.05 meters, 1000, and 1e-6, respectively. NLopt's implementation of CRS for trajectory optimization was used with a population size of 10,000 and a relative tolerance of 1e-6. Intermediate finger joints were allowed to vary within 1 centimeter. Six joints of the were allowed to deviate within 5°, 5°, 5°, 45°, 25°, and 90°, respectively.

A robot grasping position (a last keyframe) was set so that an end effector was pointing forward. The object 105 was placed right in front of the end effector, except in a case of the “Top Key” (A3), for which the end effector was pointed downwards. The optimization stage was run until three successful candidates were found or until grasp candidates ran out, whichever happened first. One candidate was chosen for fabrication for validation purposes.

A GC candidate generation step took less than a minute for each model. An insert trajectory generation step took between 7 and 26 minutes, with an average value of 13 minutes per GC candidate per model. The insert trajectory generation step terminated after running on 5 GC candidates on average and succeeded on at least one candidate on every model. Topology optimization took on average 1 hour and 26 minutes but varied largely with dimensions of a bounding box.

An entire experiment took on average 2 hours and 38 minutes per model, and on average 54% of time was spent running the topology optimization. While several computation steps can be sped up with straightforward implementation updates (for example, faster topology optimization), computation speed was suitable for practical use, particularly when considering manufacturing time.

The gripper geometries and insert trajectories 220 were highly customized for each particular object. While many insert trajectories 220 may seem obvious given a gripper, the algorithm 218 can generate non-intuitive solutions. Production of the non-intuitive solutions highlights a tightly coupled nature of the problem and a value of using co-optimization.

While all solutions were unique, gripper shapes for the evaluation set can be classified into three categories. “Inserts” can take most of a load in a single point, typically inside a cavity on the object 105, as was shown for examples A1-f, A2, A3, C1, and C2. “Tongs” can rely on a wide separation of support from underneath, as was shown for examples C7, D2, and D7. “Wrenches” can have a narrow grasp from opposite sides that distribute the load on all three grasp points, as was shown in A5 and D1. While customized to particular shapes, gripper designs can replicate standard types of simple tools.

Insert trajectories 220 most grippers follow can also fall into a triadic grouping. Most of the objects 105 can fall into a “front insert” category where the gripper moves directly in and grabs the object 105 from the bottom. Some examples of objects 105 that fall under this category include the front key (A1), the pallet (A4), a cup (D1), an orange (D7) and a challenge object (C1). Although insert trajectories 220 may seem simple, designing the insert trajectories by a user may be not trivial because the input trajectories 220 can be sensitive to approach angles and sequencing. For example, to grab the orange (D7), the gripper needs to slightly go down then insert to avoid convexity of the sphere, and to get to the front key (A1), a subtle amount of in and up motion is needed.

A number of the objects 105 can fall into a “side insert” category. In the “side insert” category, the insert trajectory 220 can include sliding horizontally into a grasping position. Some examples of objects in the “side insert” category include the wedge (A5), the Side Key (A1-s), object C2, and object C7. The algorithm 218 can find a solution even if a required motion is not perfectly straight. In the Stanford bunny (B) example, the robot may need to slightly turn to get around a convex part of the Stanford bunny (B).

The pyramid (A2) and the Top Key (A3) fall into a “twist insert” category. Objects 105 in the “twist insert” category can be designed to be grabbed only by rotation motions which the algorithm 218 can find.

Results suggest that the algorithm 218 can find success in understanding affordances of each object 105. For example, object A1 can be picked up with a front or side motion depending on an orientation of the cavity. Objects 105 with bilateral symmetry can be grasped on opposing sides, and objects 105 with recesses can have smooth insert trajectories 220.

The passive grippers were 3D printed using two materials. A material (TangoBlackPlus) with a high coefficient of friction for a contact region was used. A material (Acrylonitrile butadiene styrene) with a high stiffness and a low cost was used for the rest of the gripper. While, the two materials can be printed together in a multi-material printer, to reduce cost, a Stratasys J750 Digital Anatomy was used for the contact region and Stratasys FDM 3D Printers (Fortus 250mc, F120, F170) were used for the rest and parts were assembled.

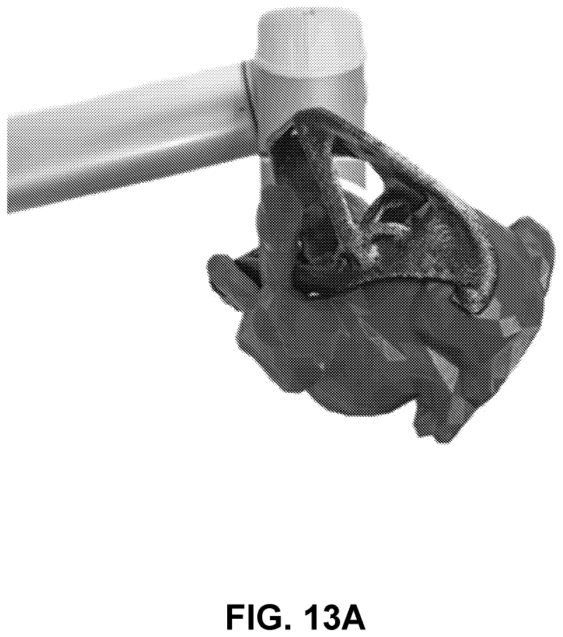

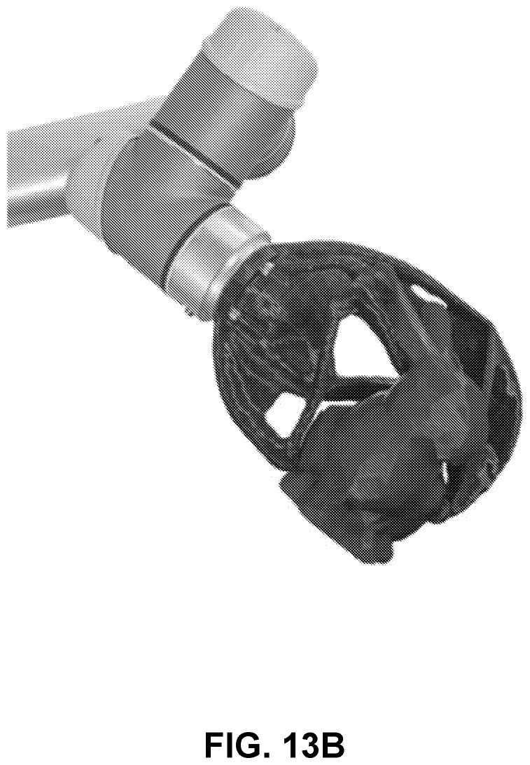

All objects 105 and printed grippers were tested on a UR5 arm in moveJ mode with insert trajectories 220 specified by the algorithm 218. Object pick up was tested as well as resistance to dropping once the object 105 was correctly seated in the gripper. Testing involved rotating clockwise, counterclockwise, and a forward roll until the object 105 fully fell out of the gripper. FIG. 13A is a schematic that illustrates a measurement of a post-grasp maximum roll angle for a passive gripper 510 according to one example of the present disclosure. FIG. 13B is a schematic that illustrates a measurement of a post-grasp maximum forward tilt angle for the passive gripper 510 according to one example of the present disclosure. For the “Top Key” object (A3), the forward roll occurred in an opposite direction due to joint limitations in the UR5 arm. Every test was repeated 10 times per object.

Of the 23 experiments, 21 led to successful pickups and results are shown in Table 2. 17 of these experiments had a 100% success rate and only two had success rates below 80%. The results, and an analysis of two failure cases, reveal that systems and methods described herein can successfully bridge a virtual-to-reality gap and can produce passive grippers that display high grasp reliability in real experiments.

TABLE 2
The number of successful pickups and maximum roll and pitch angles
before an object falls out of a gripper with ten tests per category
per object. For roll and pitch, the object was correctly loaded
into the gripper to represent stability once an object was successfully
picked up. Some objects (A3, C1, C3, C4, C6, D7) demonstrated multiple
falling modes where an object could find additional regions of
stability, resulting in large standard deviations.

| | | CW (deg) | | CCW (deg) | | Fwd Tilt (deg) | |
|---|---|---|---|---|---|---|---|
| Object | Pickups | mean | sd | mean | sd | mean | sd |
| A1-f | 10 | 170 | 3 | −162 | 6 | 68 | 9 |
| A1-s | 10 | 34 | 6 | −23 | 7 | 30 | 4 |
| A2 | 10 | 360 | 0 | −360 | 0 | 53 | 23 |
| A3 | 10 | 360 | 0 | −359 | 3 | −292 | 144 |
| A4 | 10 | 237 | 3 | −28 | 3 | 25 | 2 |
| A5 | 10 | 52 | 6 | −59 | 12 | 34 | 4 |
| B | 10 | 60 | 3 | −194 | 1 | 145 | 3 |
| C1 | 10 | 341 | 34 | −246 | 41 | 118 | 15 |
| C2 | 10 | 38 | 11 | −238 | 5 | 276 | 10 |
| C3 | 10 | 242 | 65 | −189 | 5 | 83 | 3 |
| C4 | 10 | 360 | 0 | −332 | 59 | 316 | 72 |
| C5 | 2 | 149 | 12 | −14 | 4 | 9 | 2 |
| C6 | 6 | 308 | 113 | −358 | 4 | 28 | 69 |
| C7 | 10 | 255 | 22 | −66 | 5 | 34 | 9 |
| D1 | 10 | 62 | 16 | −107 | 44 | 68 | 16 |
| D2 | 10 | 92 | 2 | −101 | 2 | 26 | 5 |
| D3 | 9 | 27 | 2 | −21 | 4 | 19 | 5 |
| D5 | 10 | 127 | 15 | −59 | 3 | 14 | 2 |
| D6 | 10 | 101 | 8 | −89 | 4 | 69 | 33 |
| D7 | 8 | 97 | 6 | −178 | 102 | 40 | 7 |
| D8 | 10 | 50 | 9 | −104 | 10 | 30 | 2 |

The two failure cases (D4 and C8, not shown in Table 2) had significant discrepancies in virtual representations of objects D4 and C8. Since gripper templates and insert trajectories 220 for objects D4 and C8 were computed over a wrong input, results may not have been well suited in practice. A 3D mesh that was used to represent bowl D4 was thinner than an actual bowl, causing the gripper to collide during an insertion. Challenge model C8 may not have been oriented in a rest position causing inaccuracies during stability analysis. Two models that had 80-90% success rates had similar discrepancies to the two failure cases. The similar discrepancies in the two 80-90% success rate models affected the gripper to a lesser extent because of symmetries in the models and locations where the discrepancies happened.

Two models (C5 and C6) with marginal stability were examples from an adversarial dataset, which can be notoriously challenging to grasp. The two marginal stability models occasionally failed because selected grasp configurations may have not left much margin for misalignment. A grasp location can be robust to avoid errors in gripper fabrication (on an order of 0.5 mm), errors in a motion of the robot (on the order of 0.1 mm), and errors in human positioning of the object 105 (on the order of 0.5 mm in a best-case scenario). These errors were not accounted for by an algorithm that evaluated stability of grasp configuration. The systems and methods were robust to these errors in all but two adversarial examples.

The complete disclosure of all patents, patent applications, and publications, and electronically available material cited herein are incorporated by reference in their entirety. Supplementary materials referenced in publications (such as supplementary tables, supplementary figures, supplementary materials and methods, and/or supplementary experimental data) are likewise incorporated by reference in their entirety. In the event that any inconsistency exists between the disclosure of the present application and the disclosure(s) of any document incorporated herein by reference, the disclosure of the present application shall govern. The foregoing detailed description and examples have been given for clarity of understanding only. No unnecessary limitations are to be understood therefrom. The disclosure is not limited to the exact details shown and described, for variations obvious to one skilled in the art will be included within the disclosure defined by the claims.

The description of embodiments of the disclosure is not intended to be exhaustive or to limit the disclosure to the precise form disclosed. While the specific embodiments of, and examples for, the disclosure are described herein for illustrative purposes, various equivalent modifications are possible within the scope of the disclosure.

Specific elements of any foregoing embodiments can be combined or substituted for elements in other embodiments. Moreover, the inclusion of specific elements in at least some of these embodiments may be optional, wherein further embodiments may include one or more embodiments that specifically exclude one or more of these specific elements. Furthermore, while advantages associated with certain embodiments of the disclosure have been described in the context of these embodiments, other embodiments may also exhibit such advantages, and not all embodiments need necessarily exhibit such advantages to fall within the scope of the disclosure.

As used herein and unless otherwise indicated, the terms “a” and “an” are taken to mean “one”, “at least one” or “one or more”. Unless otherwise required by context, singular terms used herein shall include pluralities and plural terms shall include the singular. Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

Unless otherwise indicated, all numbers expressing quantities of components, molecular weights, and so forth used in the specification and claims are to be understood as being modified in all instances by the term “about.” Accordingly, unless otherwise indicated to the contrary, the numerical parameters set forth in the specification and claims are approximations that may vary depending upon the desired properties sought to be obtained by the present disclosure. At the very least, and not as an attempt to limit the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. All numerical values, however, inherently contain a range necessarily resulting from the standard deviation found in their respective testing measurements.

All headings are for the convenience of the reader and should not be used to limit the meaning of the text that follows the heading, unless so specified.

All of the references cited herein are incorporated by reference. Aspects of the disclosure can be modified, if necessary, to employ the systems, functions, and concepts of the above references and application to provide yet further embodiments of the disclosure. These and other changes can be made to the disclosure in light of the detailed description.

It will be appreciated that, although specific embodiments of the disclosure have been described herein for purposes of illustration, various modifications may be made without deviating from the spirit and scope of the disclosure. Accordingly, the disclosure is not limited except as by the claims.

What is claimed is:

1. A method of producing a passive gripper for an object, the method comprising:
identifying a set of grasp configurations for the object;
selecting, from the set, a particular grasp configuration configured for performing passive engagement and disengagement with the object;
generating a template for the passive gripper based on the particular grasp configuration; and
fabricating the passive gripper based on the template.

2. The method of claim 1, wherein fabricating the passive gripper comprises fabricating the passive gripper by a 3D printer, a computer numerical control (CNC) machine, a laser direct metal laser melting additive machine, or other additive or subtractive manufacturing machine.

3. The method of claim 1, further comprising determining a trajectory for contacting the object at the particular grasp configuration without colliding with the object.

4. The method of claim 3, further comprising generating a generalization of passive gripper geometry, the generalization connecting the particular grasp configuration to a grasping base.

5. The method of claim 4, further comprising co-optimizing the trajectory and the generalization of passive gripper geometry.

6. The method of claim 4, wherein the grasping base corresponds to or is included on a robotic arm.

7. The method of claim 5, wherein generating the template for the passive gripper includes performing a discrete topology optimization over a collision-free volume associated with the optimized generalization of passive gripper geometry.

8. The method of claim 1, wherein identifying the set of grasp configurations for the object comprises:
randomly selecting sets of three contact points on a surface of the object;
disqualifying a subset from among the sets of three contact points, the subset containing points that are statically unstable for contact or are unreachable by a collision-free trajectory; and
ranking, from the sets of three contact points, a list of candidates for the particular grasp configuration.

9. The method of claim 8, wherein ranking the list
of candidates comprises ranking the list of candidates based at least in part on a minimum disturbance force that causes the object to become unstable or on an estimated finger length for the passive gripper.

10. A system comprising:
a robotic arm configured to move relative to an object;
a processor;
a memory that includes instructions executable by the processor for causing the processor to perform operations comprising:
identifying a set of grasp configurations for the object;
selecting, from the set, a particular grasp configuration configured for performing passive engagement and disengagement with the object; and
generating a template of a passive gripper configured to contact the object at the particular grasp configuration; and
a manufacturing device configured to fabricate the passive gripper based on the template and such that the passive gripper is attachable to the robotic arm to be configured to contact the object at the particular grasp configuration.

11. The system of claim 10, wherein the manufacturing device comprises a 3D printer, a computer numerical control (CNC) machine, a laser direct metal laser melting additive machine, or other additive or subtractive manufacturing machine.

12. The system of claim 10, wherein the operations further comprise determining a trajectory for contacting the object at the particular grasp configuration without colliding with the object.

13. The system of claim 12, wherein the operations further comprise generating a generalization of passive gripper geometry, the generalization connecting the particular grasp configuration to a point on a robotic arm.

14. The system of claim 13, wherein the operations further comprise co-optimizing the trajectory and the generalization of passive gripper geometry.

15. The system of claim 14, wherein generating the template of the passive gripper includes performing a discrete topology optimization over a collision-free volume associated with the optimized generalization of passive gripper geometry.

16. The system of claim 10, wherein identifying the set of grasp configurations for the object comprises:
randomly selecting sets of three contact points on a surface of the object;
disqualifying a subset from among the sets of three contact points, the subset containing points that are statically unstable for grasping or are unreachable by a collision-free trajectory; and
ranking, from the sets of three contact points, a list of candidates for the particular grasp configuration.

17. The system of claim 16, wherein ranking the list of candidates comprises
ranking the list of candidates based at least in part on a minimum disturbance force that causes the object to become statically unstable for grasping or on an estimated finger length for the passive gripper.

18. The system of claim 10, further comprising a scanning apparatus capable of collecting shape and position data for the object.

19. A method for producing a gripper for two or more objects, the method comprising:
identifying two or more sets of grasp configurations, each set of grasp configurations associated with one of the two or more objects;
selecting, from the two or more sets of grasp configurations, a combination of particular grasp configurations, the combination configured to grasp at least one object of the two or more objects;
generating a template for the gripper, the gripper configured to contact the at least one object using the combination of the particular grasp configurations; and
fabricating the gripper based on the template.

20. The method of claim 19, wherein each of the particular grasp configurations in the combination of the particular grasp configurations is connected to the other particular grasp configurations in the combination by a series of paths.
